(19) United States
(12) Patent Application Publication
(10) Pub. No.: US 2024/0031533 A1
(43) Pub. Date: Jan. 25, 2024

(54) AUTOMATICALLY TURNING OFF A VISUAL INTERRUPTION SYMBOL IN A VIRTUAL MEETING

(71) Applicant: Microsoft Technology Licensing, LLC, Redmond, WA (US)

(72) Inventors: Amer HASSAN, Kirkland, WA (US); Mahendra SEKARAN, Sammamish, WA (US); Robert Andreas AICHNER, Bellevue, WA (US); Ross Garrett CUTLER, Clyde Hill, WA (US); Scott Edward VAN VLIET, Sammamish, WA (US)

(73) Assignee: Microsoft Technology Licensing, LLC, Redmond, WA (US)

(21) Appl. No.: 18/265,569

(22) PCT Filed: Dec. 7, 2021
(86) PCT No.: PCT/US2021/062192

§ 371 Date: Jun. 6, 2023

(30) Foreign Application Priority Data
Dec. 7, 2020 (NL) 2027060

(51) Int. Cl. H04N 7/15; G10L 17/00

(52) U.S. Cl. CPC H04N 7/157; H04N 7/152; G10L 17/00

(57) ABSTRACT

A method and system for securing an anonymous discovery service may include receiving a request from a client device, the request being directed to an anonymous Autodiscover service, identifying a source from which the request originated from within the client device, and responsive to the source being of a first type of sources, transmitting a first response to the client and responsive to the source being of a second type of sources transmitting a second response to the client. The first response does not return a Uniform Resource Locator (URL) to a service endpoint, the second response returns a URL to a service endpoint. Furthermore, the anonymous discovery service may be a discovery service that requires no authentication.

### TECHNICAL FIELD

The present application relates to systems and methods for automatically updating meeting interfaces of an application providing a virtual meeting in response to detecting an acoustic signal and clearing a visual interruption symbol subsequent to receiving an associated interruption symbol raising signal.

### BACKGROUND

Virtual conferencing/meeting allows two or more people at multiple places to communicate with each other through video, audio, and text transmissions in an online meeting, which is particularly useful when a face-to-face meeting is unavailable or burdensome. In a virtual meeting, an attendee/participant can raise hand to indicate he/she wants to speak. With current virtual meeting systems, after the participant speaks in the meeting, either the participant has to manually lower the raised hand or the hand will be lowered down by the system after a certain period of time. A technical problem of using these hand-lowering methods is that the raised hand may not be timely lowered down, and thus negatively affect the subsequent interactions in the virtual meeting. On one hand, the manual operation places the burden of lowering the raised hand on meeting participants, and thus impairs the participants' experience in the virtual meeting (e.g., a participant has to remember to lower the hands after he/she speaks). More importantly, when or whether a participant will lower his/her hand is unpredictable. On the other hand, it is also difficult for a system to determine an appropriate time interval to lower a specific participant's hand, and therefore may cause confusions. For example, if a hand raised by a participant is not timely lowered down after the participant has talked in the meeting, the participant may be asked (e.g., by an organizer of the virtual meeting) to speak again even if he/she has no intention to do so.

Hence, there is a need for a system and method for automatically and timely lowering the hand virtually raised by meeting participants in an online virtual meeting.

### SUMMARY

In one aspect, a raising-hand management system for automatically adapting meeting interfaces of an application providing a virtual meeting in response to detecting an acoustic signal subsequent to receiving an associated interruption symbol raising signal includes a processor, and a memory, coupled to the processor, configured to store executable instructions. The instructions, when executed by the processor, cause the processor to receive an interruption signal, from a first meeting interface of the application providing the virtual meeting, wherein the first meeting interface is among a set of meeting interfaces associated with the application providing the virtual meeting on a respective set of client devices for a respective set of participants of the virtual meeting, responsive to receiving the interruption signal, send the interruption symbol raising signal over a communication network to each meeting interface of the set of meeting interfaces to turn on a visual interruption symbol from a first participant, responsive to detecting a first acoustic signal from the first participant subsequent to receiving the interruption symbol raising signal: automatically generate an interruption symbol lowering signal, and send to each of the set of client devices the generated interruption symbol lowering signal to automatically update each meeting interface and turn off the visual interruption symbol.

In another aspect, a method of automatically adapting meeting interfaces of an application providing a virtual meeting in response to detecting an acoustic signal subsequent to receiving an associated interruption symbol raising signal includes: receiving an interruption signal, from a first meeting interface of the application providing the virtual meeting, wherein the first meeting interface is among a set of meeting interfaces associated with the application providing the virtual meeting on a respective set of client devices for a respective set of participants of the virtual meeting, responsive to receiving the interruption signal, sending the interruption symbol raising signal over a communication network to each meeting interface of the set of meeting interfaces to turn on a visual interruption symbol from a first participant, responsive to detecting a first acoustic signal from the first participant subsequent to receiving the interruption symbol raising signal: automatically generating an interruption symbol lowering signal, and sending to each of the set of client devices the generated interruption symbol lowering signal to automatically update each meeting interface and turn off the visual interruption symbol.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIG. 1 is a block diagram of an example raising-hand management system.

FIG. 2 is a block diagram of example components of a raising-hand management component.

FIG. 3 is a block diagram of an overall procedure of lowering a hand raised by a participant in a virtual meeting.

FIG. 4 is a flowchart of an example method for automatically adapting meeting interfaces of an application providing a virtual meeting in response to detecting an acoustic signal subsequent to receiving an associated interruption symbol raising signal by a raising-hand management component of a virtual meeting server.

FIG. 5A is an example graphical user interface presenting a participant a “Raised Hand” option.

FIG. 5B is an example graphical user interface showing a visual interruption symbol.

FIG. 5C is an example graphical user interface showing an “unmute” reminder.

FIG. 5D is an example graphical user interface showing a lowering-hand notification.

FIG. 5E is an example graphical user interface resulting from lowering a raised hand.

FIG. 6 is a functional block diagram of an example computer system upon which aspects of this disclosure may be implemented.

### DETAILED DESCRIPTION

In the following detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

The existing virtual meeting systems include a technical problem of not being able to automatically and/or timely turn off a visual interruption symbol representing a participant's request to contribute to the virtual meeting. In one specific example, the visual interruption symbol corresponds to a raised hand symbol in Microsoft Teams® or Zoom® application. In the existing systems, the visual interruption symbol may be manually turned off by the participant at a random time he/she chooses or may be automatically turned off at a specified time after the participant talks in the meeting. In the former scenario, the participant may choose to turn off the visual interruption symbol when he/she remembers to do so, or he/she may simply forget to turn off the visual interruption symbol. Therefore, turning off the visual interruption symbol may be delayed for tens of seconds or not completed at all. In the latter scenario, without considering the interactions in the virtual meeting, the network bandwidth and speed associated with the interactions, turning off the visual interruption symbol may also experience an unreasonable long delay. For example, the visual interruption symbol may be turned off earlier when a speech from one participant is unexpectedly long, especially if other participants also raised their hands and were waiting for their turn to talk in the meeting. Therefore, one of the technical problems addressed by the instant application is to determine an appropriate time to turn off the visual interruption symbol and automatically turn off the visual interruption symbol at the determined time.

The technical solution described in the present application allows for a rapid response time in turning off a visual interruption symbol. In one implementation, the technical solution includes server(s) and client devices. The server(s) may receive an interruption signal via a meeting interface associated with a first participant for requesting permission to speak in a virtual meeting, and send an interruption symbol raising signal to each client device associated with the virtual meeting to update each meeting interface with a visual interruption symbol. The visual interruption symbol may be a raised hand symbol indicating that a first participant raises a virtual hand in the meeting via a meeting interface.

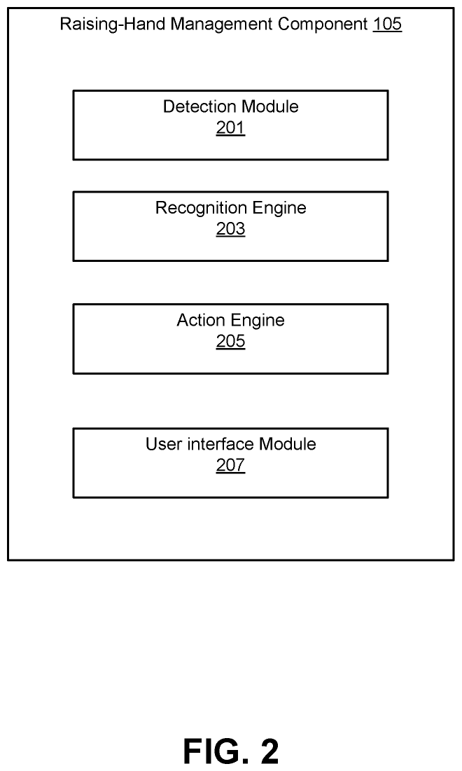

The client device associated with the first participant may then detect various acoustic signals (e.g., participant speaking, dog barking) from various sources in the environment of the virtual meeting, and determine if the detected acoustic signals include a voice from the first participant. The detected first participant's voice or a first acoustic signal received via the first meeting interface indicates that the first participant has started speaking or has contributed. The voice detection and recognition may also be implemented remotely if a specific client device is not able to handle it locally. Responsive to receiving the first acoustic signal, the server(s) may generate an interruption symbol lowering signal and send this signal to each client device to turn off the visual interruption symbol on each meeting interface, e.g., lowering the hand virtually raised by the first participant. It should be noted that, in some implementations, the client device may also detect the network traffics from the first participant and activate the generation of the interruption symbol lowering signal based on the network traffics. In such a case, the network traffics is an indication flag of a detected acoustic signal. The details of the detection of network traffics will be described in detail below with reference to FIG. 2.

To this end, the technical solution may automatically lower the raised hand symbol when detecting the first participant has started speaking without waiting for the first participant to stop talking. Therefore, a participant's hand will be lowered down in real-time once he/she starts talking. Alternatively or additionally, the technical solution may automatically lower the raised hand based on the corresponding participant's contribution/talk in the meeting and other participants' interactions in the meeting, thereby efficiently preventing one participant from dominating the meeting when others actively request to speak. The technical benefits of the technical solution described herein at least include eliminating or reducing the delay present in current virtual meeting systems, where a visual interruption symbol (e.g., a raised hand symbol) may be turned off at a random time, after a long time, or never be turned off. Additionally, by automatically generating and exchanging signals among communication channels between client devices and server(s), the functionalities are divided and efficiently implemented by corresponding server(s)/client devices, and corresponding results are reflected synchronically on meeting interfaces (e.g., the visual interruption symbol is “lowered down” at the same time on each meeting interface).

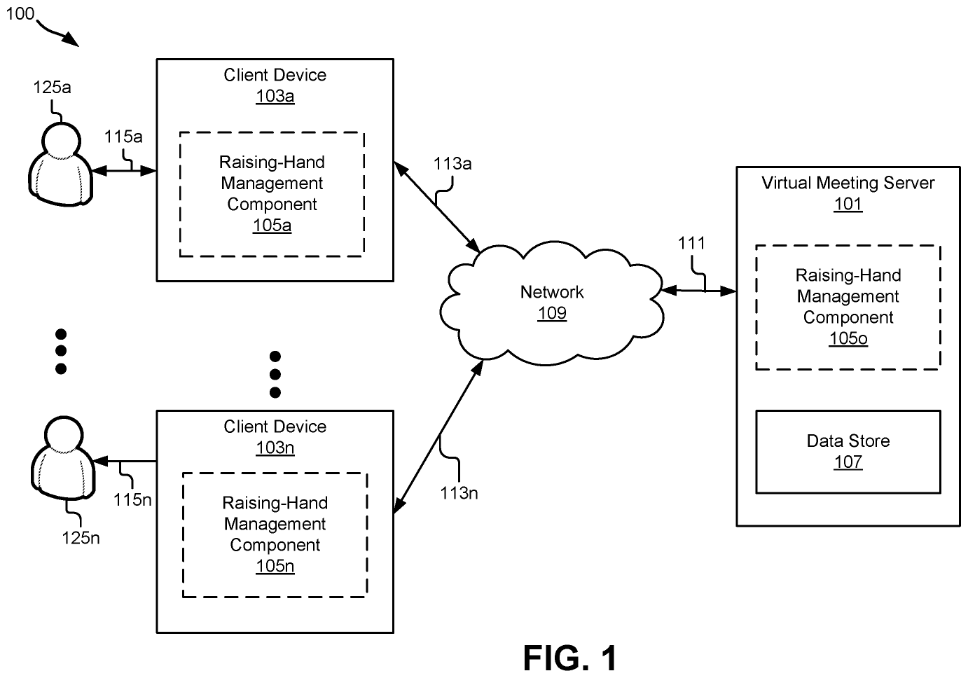

Error! Reference source not found. is a block diagram of an example raising-hand management system 100. As shown, the system 100 includes a virtual meeting server 101 and one or more client devices 103a-103n coupled for electronic communication via a network 109. It should be understood that the system 100 depicted in FIG. 1 is provided by way of example and the system 100 and/or further systems contemplated by this present disclosure may include additional and/or fewer components, may combine components and/or divide one or more of the components into additional components, etc. For example, the system 100 may include any number of virtual meeting servers 101, client devices 103a-103n, or networks 109.

The network 109 may be a conventional type, wired and/or wireless, and may have numerous different configurations including a star configuration, token ring configuration, or other configurations. For instance, the network 109 may include one or more local area networks (LAN), wide area networks (WAN) (e.g., the Internet), public networks, private networks, virtual networks, mesh networks, peer-to-peer networks, and/or other interconnected data paths across which multiple devices may communicate. The network 109 may also be coupled to or include portions of a telecommunications network for sending data in a variety of different communication protocols. In one implementation, the network 109 includes Bluetooth® communication networks or a cellular communications network for sending and receiving data including via short messaging service (SMS), multimedia messaging service (MMS), hypertext transfer protocol (HTTP), direct data connection, WAP, email, etc.

The client devices 103a-103n (or collectively client device 103) may include virtual or physical computer processors, memor(ies), communication interface(s)/device(s), etc., which along with other components of the client device 103 are coupled to the network 109 via signal lines 113a-113n for communication with other entities of the system 100. In one implementation, the client device 103a-103n, accessed by users 125a-125n via signal lines 115a-115n respectively, may send and receive data to and from other client device(s) 103 and/or the virtual meeting server 101, and may further analyze and process the data. For example, the client devices 103a-103n may communicate with the virtual meeting server 101 to generate and update a meeting interface for display on each of the client devices 103a-103n. Non-limiting examples of client device 103 may include a laptop computer, a desktop computer, a tablet computer, a mobile telephone, a personal digital assistant (PDA), a mobile email device, or any other electronic devices capable of processing information and accessing the network 109.

In one implementation, the client devices 103a-103n include instances 105a-105n of a raising-hand management component 105. The raising-hand management component 105 may automatically turn off a visual interruption symbol for a participant in a virtual meeting based on detecting that the participant has contributed to the meeting, and update meeting interfaces associated with client devices 103a-103n to reflect that a status change of the participant for the participant to all meeting participants. The raising-hand management component 105 will be described in more detail below with reference to FIG. 2.

The virtual meeting server 101 is a computing device that communicates with one or more client devices 103 to host an online virtual meeting and to process the data exchanged with the one or more client devices 103. In one implementation, the virtual meeting server 101 receives a request from the user 125a (e.g., a meeting organizer) via the client device 103a to establish a virtual space of an online meeting. The virtual meeting server 101 supports chat service, calling service, and other services so that multiple participants can hear, see, chat, and share data with each other in the virtual space. The virtual meeting server 101 may also track and analyze the communication messages/signals used in the virtual meeting to instruct one or more client devices 103 to automatically update the meeting interfaces with information of turning off a visual interruption symbol for a specific participant. In one implementation, the virtual meeting server 101 may include a server-side application to communicate with client-side applications residing on the client devices 103, and to provide the virtual meeting to participants via meeting interfaces. The application may be Microsoft Teams® application, Zoom® application, etc. The virtual meeting server 101 is communicatively coupled to the network 109 via signal line 111.

As depicted, the virtual meeting server 101 also includes an instance of the raising-hand management component 105o. For example, the raising-hand management component 105o may be part of the serve-side application providing the virtual meeting while the raising-hand management component 105a-105n are included in corresponding client-side applications installed on the client server 103a-103n. Each instance 105a-105o may include one or more components of the raising-hand management component 105 depicted in FIG. 2, and may be configured to fully or partially perform the functionalities described therein depending on where the instance resides. In one implementation, the virtual meeting server 101 may be a cloud server that possesses larger computing capabilities and computing resources than the client device 103a, and therefore may perform more complex computation than the client device 103a can. For example, the virtual meeting server 101 may determine that a participant has contributed to a virtual meeting based on detecting the participant's voice, and instruct the client devices 103 associated with all meeting participants to update a corresponding meeting interface for display. The virtual meeting server 101 may also include a data store 107 to store data received from multiple client devices 103 and any other data generated and required for implementing the functionalities related to the virtual meeting server 101.

Depending on system configuration and application requirement, the implementation of functionalities may be balanced among different entities of the system 100 as reflected in the first and second scenarios described below. The system configuration includes, but is not limited to, types of client devices 103 associated with a virtual meeting, geographical locations of the client devices 103, type and location of the virtual meeting server 101, network bandwidth, network speed, etc. The application requirement includes, but is not limited to, a total number of client devices 103 associated with the virtual meeting, a percentage of the total number of client devices 103 with limited capacities (e.g., handheld devices), etc.

In the first scenario, in response to receiving an interruption signal from a first meeting interface of a participant in a virtual meeting, the client device 103 associated with the participant may detect the participant's voice in the meeting and determine that the participant has contributed to the meeting. The interruption signal may be generated in response to the participant raising his/her virtual hand in the meeting. Once the determination is made locally, the client device 103 may reach out to the virtual meeting server 101 to modify the participant's status (e.g., changing a hand-raising status to a hand-lowering status) and update user interfaces of all meeting participants accordingly. In this scenario, the client device 103 exchanges a limited amount of data and signals with the virtual meeting server 101, thereby reducing the consumption of bandwidth. Also, the virtual meeting server 101 may generate a signal for updating the meeting interfaces in real time, thereby reducing the processing latency. This is particularly advantageous when a large number (e.g., more than a threshold number) of users join the virtual meeting and/or when a certain percentage (e.g., more than a threshold percentage) of the client devices 103 used for accessing the meeting have relatively high capacities (e.g., desktop computers rather than handheld devices).

In a second scenario, instead of certain client devices 103 locally detecting and determining whether a participant is speaking or has spoked in the virtual meeting, the virtual meeting server 101 may take over such functionalities and further signal client devices 103 associated with meeting participants to update the meeting interfaces accordingly. Since the virtual meeting server 101 performs a significant amount of computation and processing, client devices 103 in this scenario can be handheld devices with limited capacities. As compared to the first scenario, the lower device requirement may allow more users to join the virtual meeting, thereby improving the compatibility and feasibility of the virtual meeting system. However, the client devices 103 may exchange a large amount of data/signals with the virtual meeting server 101 for implementing the required functionalities, which may increase the bandwidth usage and processing time.

FIG. 2 is a block diagram of example components of a raising-hand management component 105. The raising-hand management component 105 includes hardware and/or software logic for receiving an interruption signal representing a first participant's request to contribute to a virtual meeting and detecting whether the first participant actually contributes to the virtual meeting. Once the first participant has contributed to the meeting, the raising hand management component 105 generates an interruption symbol lowering signal to turn off a visual interruption symbol, e.g., lowering the raised hand for the first participant, and updates each meeting interface associated with each client device to show that the first participant's hand is lowered to other meeting participants. By automatically lowering the raised hand of a participant based on detecting that the participant has spoked in the meeting, the raising-hand management component 105 relieves the participant from manually turning off the visual interruption symbol (e.g. lowering his/her hand) and also avoids any confusion caused by not timely turning off the visual interruption symbol (e.g., the participant may be asked to speak again because of an outdated “raised hand” status), thereby improving user navigation experience and increasing operational efficiency.

In one implementation, the raising-hand management component 105 includes a detection module 201, a recognition engine 203, an action engine 205, and a user interface module 207. The detection module 201 receives an interruption signal from a participant of a virtual meeting (e.g., a first participant) and, in response, detects acoustic signals from the virtual meeting environment. The interruption signal represents the first participant's request to contribute to the virtual meeting. In one implementation, the first participant may send an interruption signal via a first meeting interface associated with the first participant to request to speak in the meeting without interrupting the meeting. The first meeting interface is among meeting interfaces associated with the virtual meeting that are displayed on the client devices 103 for each meeting participant. For example, the first participant may signal that he/she wishes to speak or contribute to the meeting by selecting/tapping/touching a “Raise Hand” option included in the first meeting interface. In one implementation, the interruption signal is associated with a timestamp. The timestamp shows the time that the first participant requested permission to speak.

The detection module 201 residing on the client device 103a associated with the first participant may receive the interruption signal and communicate with other module(s)/engine(s) of the raising-hand management component 105a for locally processing the signal. In another implementation, the signal may also be transmitted over a communication network (e.g., the network 109) to the detection module 201 residing on the virtual meeting server 101 for processing remotely.

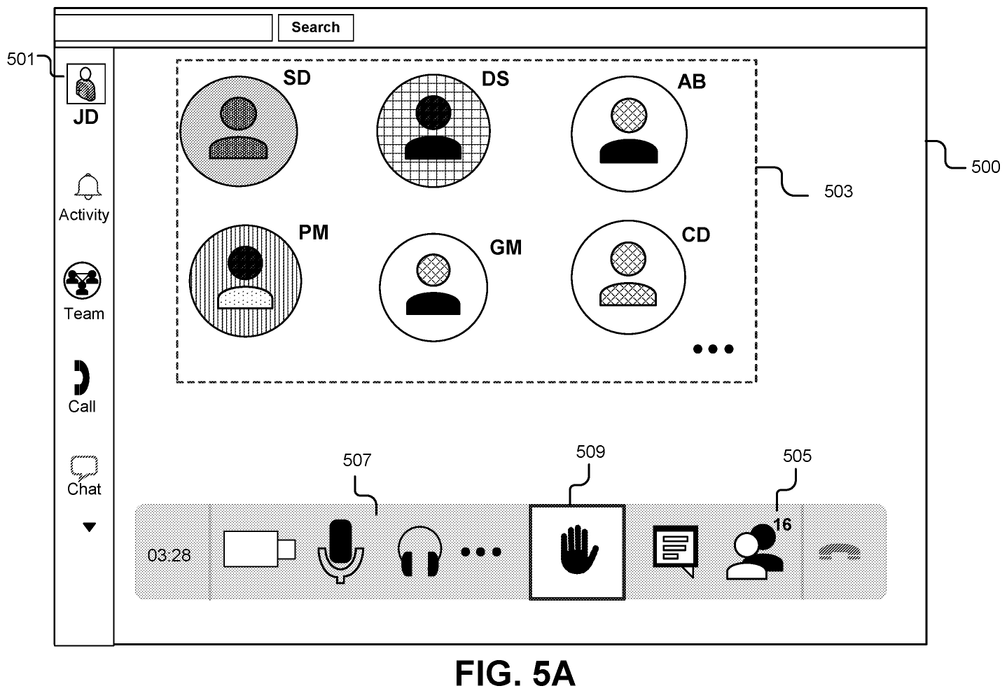

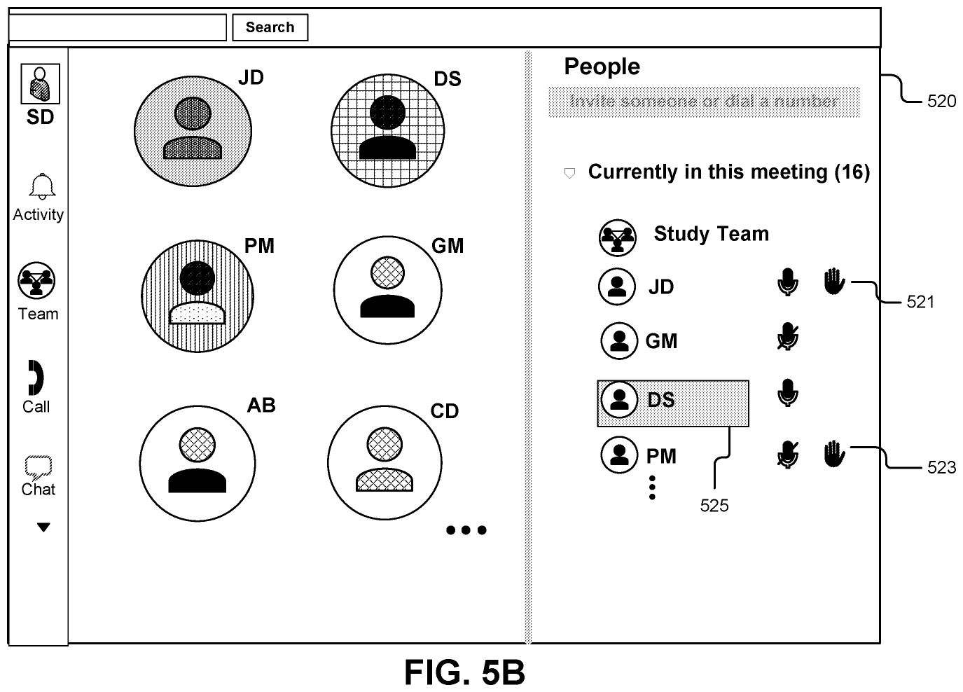

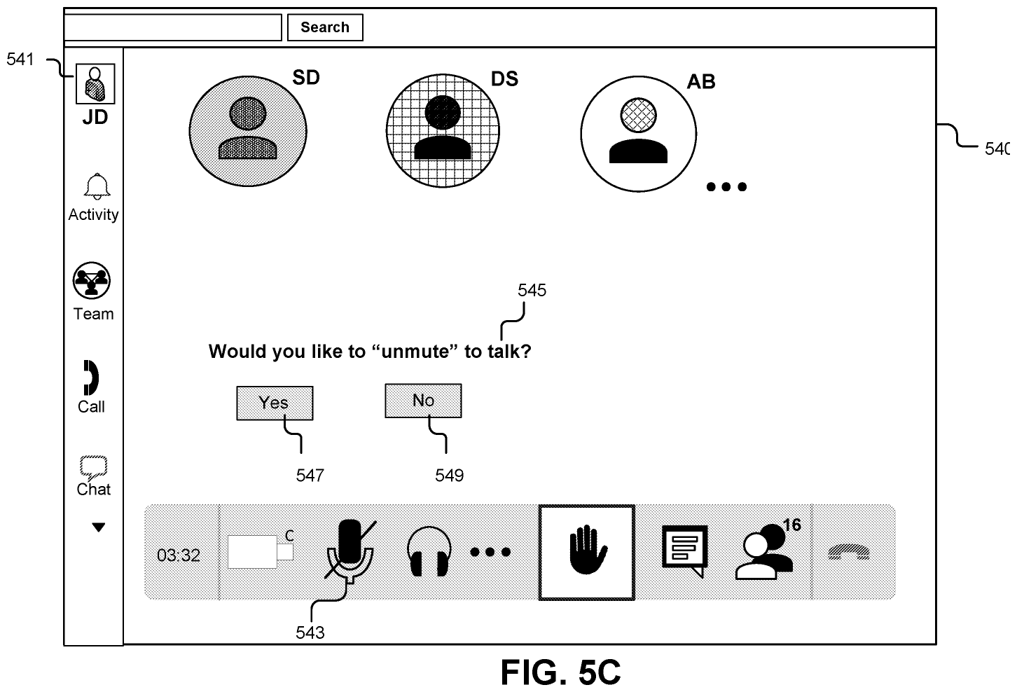

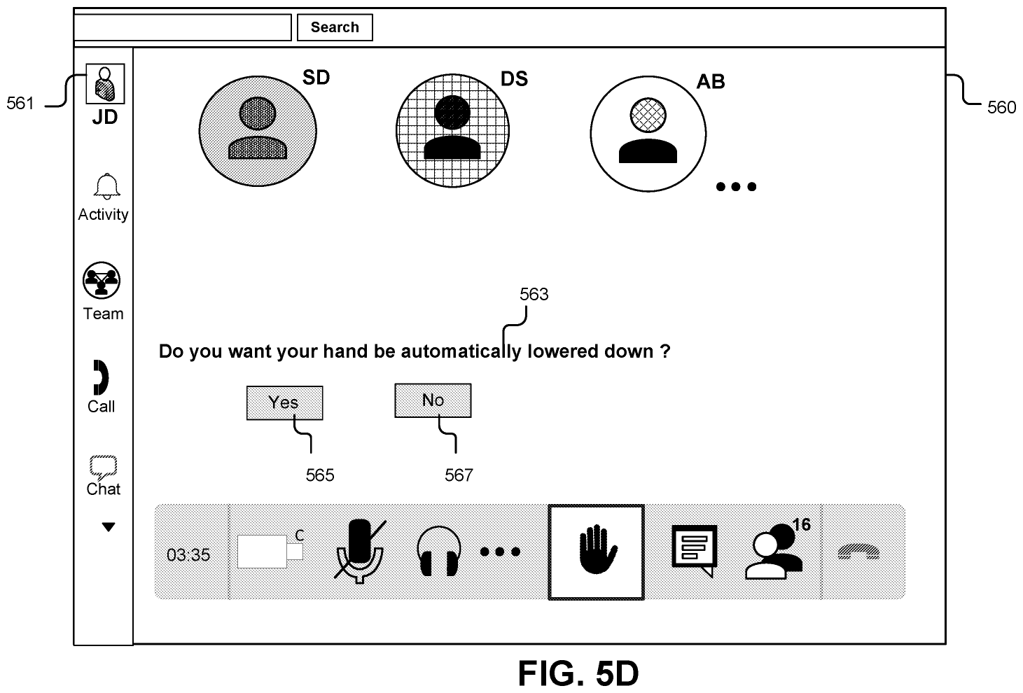

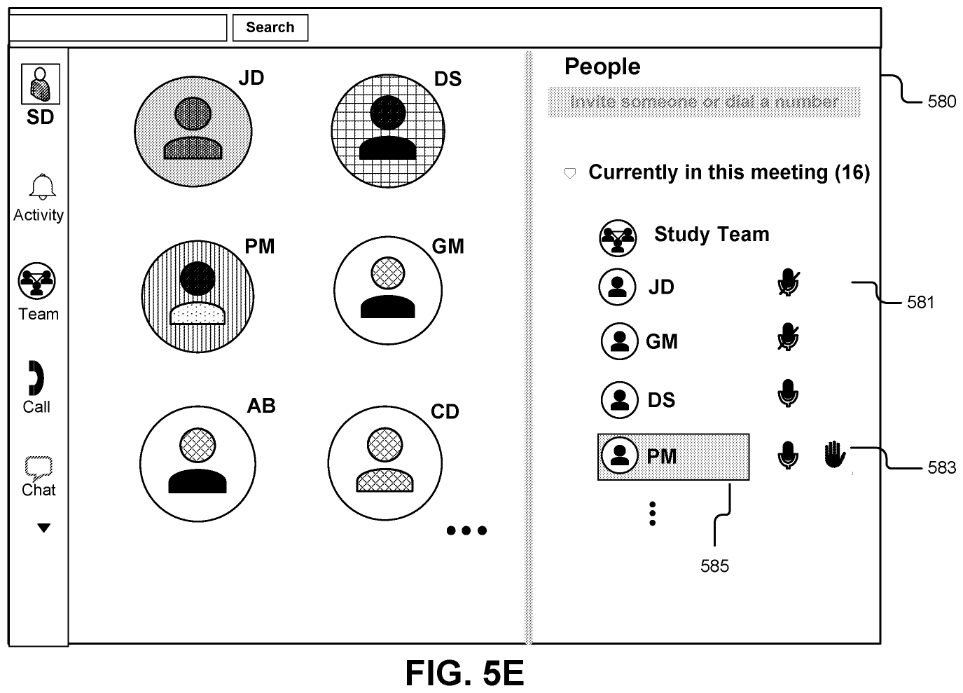

In one implementation, in response to receiving the interruption signal indicating that the first participant requests to contribute to the meeting, the detection module 201 may generate and send an interruption symbol raising signal over a communication network (e.g., the network 109) to each of the client devices 103 to turn on, on each meeting interface associated with each participant, a visual interruption symbol for the first participant. The visual interruption symbol may be an icon, a flag, a button, or other types of graphical symbol that identifies a unique “raised hand” status, that is, the first participant is requesting permission to speak or contribute. For example, the visual interruption symbol is a raised hand symbol as depicted in FIG. 5B.

Responsive to receiving the interruption symbol raising signal, the detection module 201 also detects acoustic signals from the virtual meeting environment. The virtual meeting environment may include a conference room, an office, or other places where a participant joins the virtual meeting. The acoustic signals may include various types of voices and non-voice noises from various sources in the virtual meeting environment, for example, a person talking, a dog barking, a television playing a movie, a car passing by, a kid laughing, etc. The detection module 201 may detect the acoustic signals for a predefined amount of time, for example, a couple of seconds or minutes. Alternatively, the detection module 201 may track a certain acoustic signal until the signal disappears. The detection module 201 identifies one or more timestamps of an acoustic signal for storing as part of metadata associated with the acoustic signal. A timestamp may indicate a start time, an end time, and/or a duration of an acoustic signal, which may be used in voice recognition as described below with reference to the recognition engine 203.

In one implementation, the detection module 201 further detects a specific client device (e.g., client device 103a) that the first participant uses for accessing the virtual meeting. If the first meeting interface includes a “mute” button/option, the detection module 201 also detects a mute status or an unmute status of the first meeting interface. The mute status indicates that the “mute” button is on and the unmute status indicates that the “mute” button is off. The detection module 201 transmits the detected acoustic signals, the metadata (e.g., timestamps), and other detected information to the recognition engine 203 and the action engine 205 for further processing.

In addition to detecting the acoustic signals, the detection module 201 may also detect other network traffics from the first participant via the first meeting interface. For example, when the “mute” button of the first meeting interface is on and the first participant is speaking, the detection module 201 may capture the data packets associated with the first participant's speech although the first participant's voice or acoustic signal is not transmitted over the network. The detection module 201 may transmit the captured data packets to the recognition engine 203 to signal the first participant's contribution. In such scenario, a reminder is often generated and displayed to the first participant to turn off the “mute” button. It should be noted that, since the voice is not transmitted over the network, only the detection module 201 residing on a local client device (not the remote server) can receive the data packets or detect such network traffic signal. The network traffic signal is an indication flag of a detected acoustic signal. For simplicity and clarity, the disclosure hereafter mainly focuses on operations relating to detecting an acoustic signal, although the acoustic signal and the network traffic signal may be exchangeable in certain scenarios.

The recognition engine 203 analyzes the detected acoustic signals received from the detection module 201 to recognize the voice from the first participant who raised his/her hand in the virtual meeting. To be heard and understood by other participants in the virtual meeting, the first participant who requests to contribute to the meeting usually speaks with a certain intensity and/or a certain length. In one implementation, the recognition engine 203 may determine an intensity level for each of the acoustic signals and identify, from the acoustic signals, one or more acoustic signals having the intensity level exceeding a threshold level. The threshold level may be set relative to a background intensity level that is predetermined or measured in a preceding time-period. For example, the threshold level may be a set amount above and/or a multiple of the background intensity level. The background intensity level may also be set taking account of a background threshold filter. Using a background threshold filter helps avoid the background intensity level being set too low due to periods of silence between background noises. One or more participants may also be able to adjust the threshold level if it is not accurately distinguishing the acoustic signals from the background noises. This has the effect of letting the one or more participants adjust the sensitivity of the system to their voice or the voice of another participant. By using thresholding, the recognition engine 203 may remove low-intensity acoustic signals such as distant background noises, for example, the sound of moving furniture in the far-end of the room. In some cases, the recognition engine 203 may identify, from the acoustic signals, one or more acoustic signals according to whether criteria are satisfied. The criteria can include one or more of: upper and/or lower thresholds on intensity, upper and/or lower thresholds on the rate of change of intensity, frequency ranges, frequency distributions, and limits on the variations in frequency distribution. As described above for threshold levels, one or more participants may also be able to adjust the criteria to improve the filtering of the acoustic signals from the background noises. In another implementation, the recognition engine 203 may retrieve length information of the acoustic signals from the associated timestamps and filter the acoustic signals based on the length of the acoustic signals. The recognition engine 203 may rule out the acoustic signals with a length less than a threshold length, for example, a sudden sneeze.

Responsive to obtaining the one or more filtered acoustic signals based on the intensity and/or length examination, the recognition engine 203 may recognize the voices of one or more meeting participants from the filtered signals. In one implementation, the recognition engine 203 separates a human voice from non-voice noises (e.g., a loud dog barking) based on audio pattern recognition. The recognition engine 203 then determines if the voices of one or more meeting participants include the voice of the first participant who has raised his/her hand and activated the interruption signal. For example, the recognition engine 203 identifies a voice from a registered device (e.g., a handset, a desktop) of the first participant and determines that the voice belongs to the first participant. In one implementation, the information associated with the meeting participants such as their registered devices, geographical locations, calendars, etc., are stored in a database (e.g., the data store 107 of the virtual meeting server 101). The recognition engine 203 retrieves the stored information associated with the first participant for identifying a voice from the first participant. In another implementation, a voice sample from the first participant may also be stored in the database, which allows the recognition engine 203 to match the received voice to the stored voice sample and to identify and authenticate the first participant's voice based on the voice match.

Once recognizing the first participant's voice, the recognition engine 203 determines that a first acoustic signal reflecting the first participant's contribution to the virtual meeting is received from the first participant. In one implementation, the recognition engine 203 transmits the first acoustic signal to the action engine 205. The first acoustic signal or the recognition of the first participant's voice indicates that the first participant has started speaking, which may trigger the action engine 205 to modify the hand-raising status for the first participant, i.e., lowering the hand virtually raised by the first participant.

It should be noted that the first acoustic signal is not a voice command for turning off a visual interruption symbol. The first acoustic signal is automatically generated responsive to the first participant requesting to speak in the meeting and actually having spoken in the meeting upon the request. The content of the first participant's speech is irrelevant to the generation of the first acoustic signal. The first participant may have asked a question, answered a question, addressed to a specific participant, etc. As long as the first participant has contributed to the meeting, the first acoustic signal is generated. Although this signal may later be used to turn off a visual interruption symbol, when generated, the signal is only related to the first participant's contribution. Therefore, the first acoustic signal is not a voice command controlling a system operation such as “hi system, turn off the visual interruption symbol.”

In one implementation, the action engine 205 may turn off a visual interruption symbol (e.g., lowering the hand raised by the first participant) responsive to receiving the first acoustic signal reflecting the first participant's contribution to the virtual meeting. The visual interruption symbol (e.g., an icon, a flag) for the first participant is turned on, on each meeting interface associated with each participant after an interruption signal from the first meeting interface of the application providing the virtual meeting is received responsive to the first participant raising his/her hand. Therefore, to lower the raised hand, the action engine 205 automatically generates an interruption symbol lowering signal and sends the interruption symbol lowering signal to each of the client devices 103 such that the user interface module 207 (described below) of the client devices 103 can automatically update the display of each meeting interface and turn off the visual interruption symbol. For example, the action engine 205 may automatically remove a flag representing the “raised hand” status of the first participant from the display of all meeting interfaces associated with other attendees or participants, as a result of turning off the visual interruption symbol.

The action engine 205 may lower the first participant's hand in two scenarios: (1) after detecting that the first participant starts talking or (2) after detecting that the first participant stops talking. In the first scenario, the action engine 205 may generate the interruption symbol lowering signal to lower the “raised hand” after a specific amount of time of detecting that the one or more voices include the voice from the first participant or receiving the first acoustic signal. For example, the action engine 205 may lower the hand by turning off the visual interruption symbol after the first participant has started speaking for the amount of time (e.g., five seconds). The hand may be lowered when the first participant is still talking.

In one implementation, the specific amount of time is predetermined. In another implementation, the specific amount of time may be determined based on participant interactions in the virtual meeting. For example, the action engine 205 may hold on generating the interruption symbol lowering signal to lower the first participant's raised hand until a certain interaction occurs, e.g., detecting a response from a second participant. In yet another implementation, the action engine 205 may also combine a mute/unmute status of the first meeting interface to determine a specific time to generate the interruption symbol lowering signal after detecting the first participant's voice. Typically, the first meeting interface includes a “mute” button/option that the first user can click/tap/select to switch on/off. The first meeting interface is in an unmute status when the “mute” button is off. The first meeting interface is in a mute status when the “mute” button is on. If the first participant's voice is detected or recognized, i.e., the first acoustic signal is received, an unmute status may indicate that the first participant is still talking or going to talk (e.g., after a short pause). In this case, the action engine 205 may determine not to lower the hand raised by the first participant until a specific amount of time lapses or a specific event/interaction occurs in the virtual meeting. However, a mute status may indicate that the first participant has stopped talking. As a result, the action engine 205 may determine to lower the raised hand.

In the second scenario, the action engine 205 may generate the interruption symbol lowering signal upon detecting that the one or more voices no longer include the voice from the first participant, i.e., when the recognition engine 203 detects no more voice of the first participant from the acoustic signals tracked by the detection module 201. In other words, the action engine 205 lowers the first participant's hand after he/she has done talking in the meeting.

In one implementation, prior to automatically generating the interruption symbol lowering signal, the action engine 205 may cooperate with the user interface module 207 to notify, via the first meeting interface, the first participant of generating the interruption symbol lowering signal. Therefore, the first participant knows that he/she does not need to manually lower his/her raised hand as the hand will be automatically lowered. The action engine 205 may also communicate with the user interface module 207 to provide, on the first meeting interface, the first participant an option to configure whether to receive a notification of the interruption symbol lowering signal. The first participant, who chooses not to receive the notification, may not notice his/her raised hand indication is turned off or disappears.

In one implementation, the action engine 205 may also instruct the user interface module 207 to generate other notifications. In the virtual meeting, the first participant's voice may be captured but not transmitted to other participants when the “mute” button is on. If the first participant's hand has been raised, the captured voice may show that the first participant is ready to speak. Therefore, the action engine 205 may generate a prompt and instruct the user interface module 207 to provide the prompt to the first meeting interface associated with the first participant. The prompt reminds the first participant to switch the “mute” button to “off” so that the first participant may actually speak in the virtual meeting. Alternatively, the action engine 205 may also automatically turn off the mute button for the first participant going to speak in the meeting, for example, when the intensity level of the first participant's voice exceeds a certain threshold, or when a threshold amount of time after receiving the interruption signal from the first participant requesting to talk has passed, or when a selection of a configuration option for “automatically turning off the mute button” is received via the first meeting interface associated with the first participant.

The user interface module 207 receives instruction(s) from the action engine 205 to send graphical data to the client device 103, causing the client device 103 to present a user interface to a user or a participant. Example user interfaces are shown in FIGS. 5A-5F. In one implementation, the user interface module 207 generates the graphical data for providing a user interface that presents a selectable “Raised Hand” option to a participant or displays a visual interruption symbol for the participant once the participant selects the “Raised Hand” option. In another implementation, the user interface module 207 may generate a notification or a prompt for display on the meeting interface associated with one or more users. In yet another implementation, the user interface module 207 may generate a meeting interface that allows a participant to provide input for configuring specific functionalities. The user interface module 207 may generate graphical data for providing other user interfaces to meeting participants.

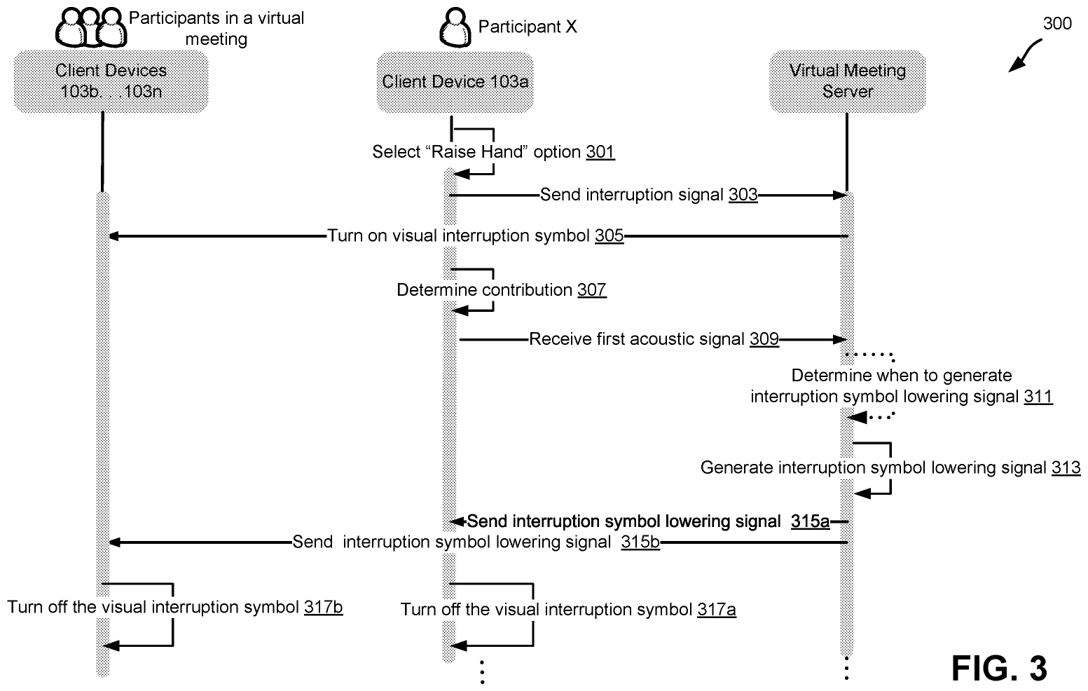

FIG. 3 is a block diagram of an overall procedure 300 of lowering a hand raised by a participant in a virtual meeting. Each participant uses a client device 103 to join the virtual meeting. One of the participants of the virtual meeting, participant X, selects a “Raise Hand” option at 301 via a meeting interface displayed on the client device 103a. The selection triggers an interruption signal to be sent at 303 to a virtual meeting server 101. In one implementation, this selection may also trigger a visual interruption symbol (e.g., a raised hand symbol) to be turned on and displayed on the meeting interface associated with participant X. Responsive to receiving the interruption signal, at 305, the virtual meeting server 101 communicates with each client device 103 to update the meeting interface associated with each participant in the virtual meeting and turn on a visual interruption symbol on each meeting interface.

It is then determined whether participant X has contributed or spoked in the meeting. At 307, the client device 103a detects a contribution of participant X. At 309, the client device 103a sends a first acoustic signal reflecting the detected contribution to the virtual meeting server 101. Responsive to receiving the first acoustic signal, the virtual meeting server 101 determines when to generate an interruption symbol lowering signal at 311, for example, after detecting that the meeting interface associated with participant X is in an unmute status or after receiving a response from a different participant, e.g., participant Y. The virtual meeting server 101 then generates the interruption symbol lowering signal at 313 and sends this signal to all meeting participants including participant X at 315a and 315b. Once the client devices 103 associated with all participants receive the interruption symbol lowering signal, each client device 103 updates the corresponding meeting interface with the visual interruption symbol for participant X being turned off, as shown at 317a and 317b.

FIG. 3 illustrates the functionality division among the virtual meeting server 101 and client devices 103 associated with the meeting participants. Some operations, for example, operations on meeting interfaces such as 301, 317a and 317b, are locally implemented by the client devices 103. Some operations, for example, signaling all client devices 103 such as 305, 315a, and 315b, are remotely implemented by the virtual meeting server 101. However, certain operations, for example, the dashed-lined step 311, may be implemented either by the client device 103 or by the virtual meeting server 101. As illustrated, the virtual meeting server 101 may track the activities in the virtual meeting, and perform step 311 to determine that an interruption symbol lowering signal may not be generated until a certain interaction happens, for example, participant Y starts talking, a response from participant Z is received, etc. However, if there is no need to obtain information of participants and/or interactions other than participant X in the virtual meeting, the client device 103a associated with participant X alone may make a local decision about at what time to lower participant X's hand without communicating to the virtual meeting server 101 or other infrastructure. For example, the client device 103a may detect that participant X is done talking, and, responsive to the detection, notify the virtual meeting server 101 to generate an interruption symbol lowering signal to have the visual interruption symbol for participant X on each meeting interface to be removed. By generating a single signal at 305 or 315 to activate the update of multiple meeting interfaces on multiple devices, the client devices 103a-103n and the virtual meet server 101 at least harmonize and synchronize the signals transmitted among these entities. This further facilitates the communications and advances the latency reduction for turning off the visual interruption symbol.

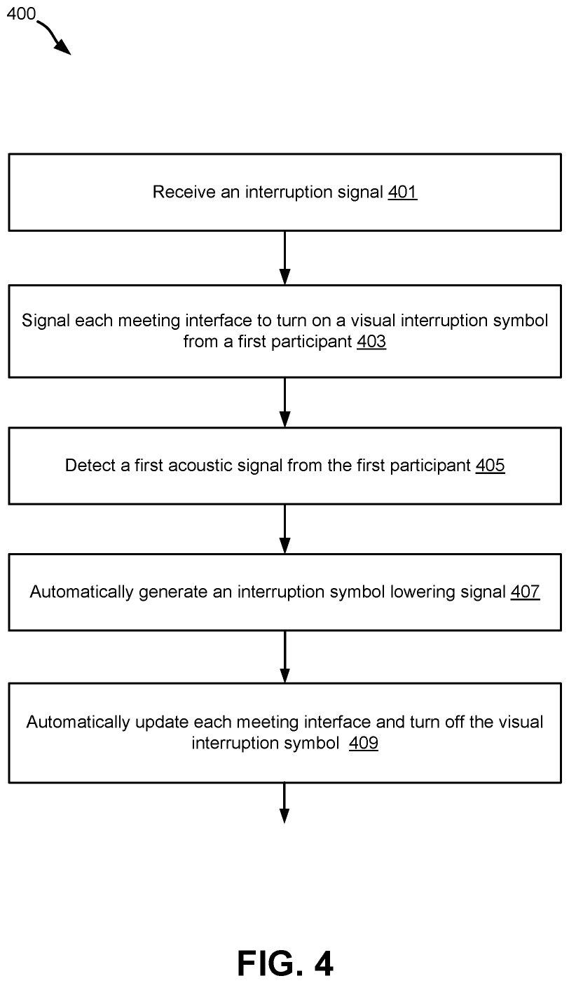

FIG. 4 is a flowchart of an example method 400 for automatically adapting meeting interfaces of an application providing a virtual meeting in response to detecting an acoustic signal subsequent to receiving an associated interruption symbol raising signal by a raising-hand management component 105 of the virtual meeting server 101. In one implementation, the raising-hand management component 105 residing on the virtual meeting server 101 may perform steps 401-409 in this figure to identify that a participant raises his/her hand to request permission to talk in the virtual meeting and to instruct the client devices 103 to lower the participant's hand after he/she has talked in the meeting.

At block 401, the raising-hand management component 105 receives an interruption signal, from a first meeting interface of an application providing a virtual meeting. The interruption signal represents the first participant's intention/request to contribute to the virtual meeting. The first meeting interface is among a set of meeting interfaces associated with the application providing the virtual meeting on a respective set of client devices 103 for a respective set of meeting participants. At block 403, the raising-hand management component 105 sends an interruption symbol raising signal over a communication network to each client device to turn on, on each meeting interface of the set of meeting interfaces, a visual interruption symbol from the first participant. The visual interruption symbol may be an icon, a flag, a button, or other types of graphical symbol that identifies a unique “raised hand” status, that is, the first participant is requesting permission to speak or contribute.

At block 405, the raising-hand management component 105 detects, from the first participant and over the communication network, a first acoustic signal subsequent to receiving the interruption symbol raising signal. The first acoustic signal reflects the first participant's contribution to the virtual meeting. In one implementation, the raising-hand management component 105 detects acoustic signals from various sources of the virtual meeting environment, analyzes the detected acoustic signals to filter out non-voice noises, and recognizes the voice of the first participant from the remaining voices. The raising-hand management component 105 recognizes the first participant's voice based on the intensity level, the length, and/or other characteristics of the acoustic signals and using audio pattern recognition algorithm(s). The recognition of the first participant's voice is an indication of the first participant's contribution to the virtual meeting, which activates the generation and transmission of the first acoustic signal.

At block 407, responsive to the received first acoustic signal, the raising-hand management component 105 automatically generates an interruption symbol lowering signal. The interruption symbol lowering signal is used to lower the hand raised by the first participant. At block 409, the raising-hand management component 105 sends to each of the client devices the generated interruption symbol lowering signal to automatically update each meeting interface and turn off the visual interruption symbol. For example, the raising-hand management component 105 may automatically remove a flag representing the “raised hand” status of the first participant from the display of all meeting interfaces associated with other attendees or participants, as a result of turning off the visual interruption symbol.

FIG. 5A illustrates an example graphical user interface 500 presenting a participant a “Raised Hand” option. The user interface 500 is a meeting interface associated with an online virtual meeting that is displayed for a specific meeting participant (i.e., user JD at 501). The meeting interface 500 includes an area 503 for displaying visual representations of participants. Although the total number of the participants of the virtual meeting is 16 as shown in 505, only partial participants are displayed in area 503 due to the limited spaces. The icon showing the total number of meeting participants is included in an action bar 507. The action bar 507 also includes a time indicator showing the progress of the virtual meeting as well as other options, for example, a “Raise Hand” option in 509. When a meeting attendee or participant wants to express the desire to speak, the participant can simply click on the “Raise Hand” option 509 to raise a virtual hand.

FIG. 5B illustrates an example graphical user interface 520 showing a visual interruption symbol. Once JD selects the “Raised Hand” option shown in FIG. 5A, a visual interruption symbol 521 is displayed on the meeting interface 520 to show the virtual hand raised by JD. In one implementation, an interruption symbol raising signal is generated to initiate the update of the user interface to show the visual interruption symbol. In the user interface 520, the visual interruption symbol 523 shows that PM also raised a hand to express his/her request to speak. However, neither JD nor PM is speaking in the meeting. Instead, DS in the shaded box 525 is speaking in the meeting. Only if JD and PM have talked or contributed in the meeting, their “raised hand” indicated by the visual interruption symbols 521 and 523 will be lowered.

FIG. 5C illustrates an example graphical user interface 540 showing an “unmute” reminder. The user interface 540 is JD's meeting interface when JD at 541 is ready to talk after raising his/her hand. The raising-hand management component 105 may capture JD's voice but do not transmit it to other client devices because JD is muted as shown in 543. The raising-hand management component 105 may generate a notification 545 to remind JD whether he/she wants to be unmuted to talk. If JD wants to speak in response to his/her raising hand request, he/she may choose “Yes” in 547. As a result, the raising-hand management component 105 may automatically unmute JD. Otherwise, JD can choose to remain muted by click “No” in 549. Alternatively, unlike in FIG. 5C, the raising-hand management component 105 may automatically unmute JD to transmit his/her voice to be heard by other meeting participants.

FIG. 5D illustrates an example graphical user interface 560 showing a lowering-hand notification. The user interface 560 is the meeting interface of participant JD at 561 after JD has talked in the meeting in response to his/her raising hand request. In one implementation, the raising-hand management component 105 generates an interruption symbol lowering signal in response to receiving an acoustic signal reflecting that JD has contributed to the meeting. Before actually acting to lower down JD's raised hand, the raising-hand management component 105 generates a notification 563 to JD. Depending on whether JD wants to speak again or continue speaking, JD can choose “Yes” in 565 or “No” in 567. The raising-hand management component 105 would either automatically clear the visual interruption symbol for JD (i.e., lowering down JD's hand) or keep the visual interruption symbol unchanged.

FIG. 5E illustrates an example graphical user interface 580 resulting from lowering a raised hand. Once the raising-hand management component 105 generates an interruption symbol lowering signal in response to detecting that JD has contributed to the meeting, the raising-hand management component 105 acts to turn off JD's visual interruption symbol 521 as shown in FIG. 5B. As a result, JD is no longer labeled with a visual interruption symbol in 581. However, PM's visual interruption symbol 583 is still on and PM is speaking as shown in 585. Once PM is done talking, the raising-hand management component 105 will also automatically clear the visual interruption symbol 583 for PM.

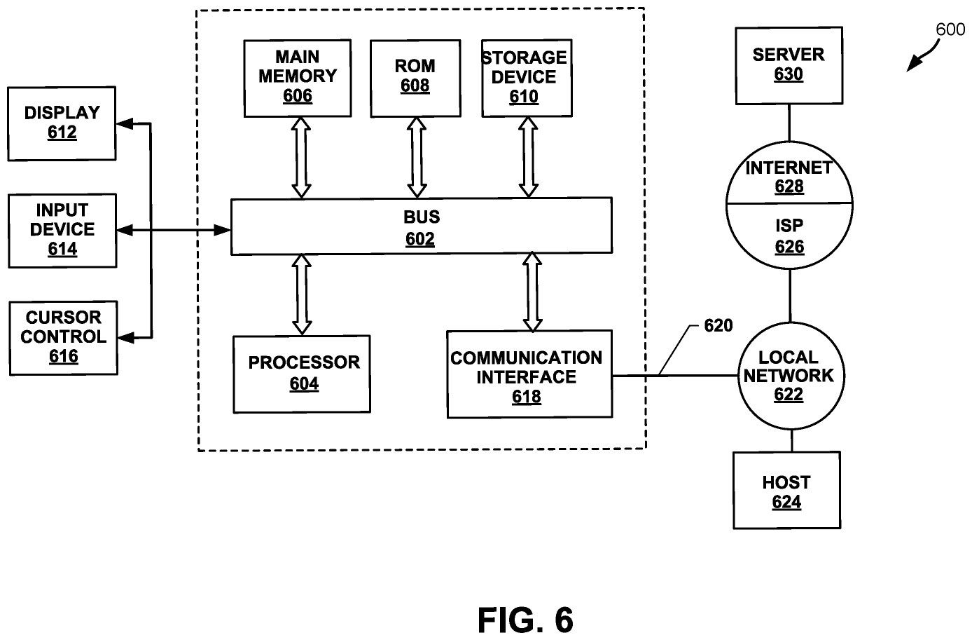

FIG. 6 is a functional block diagram of an example computer system 600 upon which aspects of this disclosure may be implemented. It will be understood that the logic blocks illustrated in FIG. 6 represent functions, and do not necessarily correspond to particular hardware on a one-to-one basis. The computer system 600 can include a data processor 604, coupled by a bus 602 to an instruction memory or main memory 606, a read-only memory 608, and a storage device 610. The instruction memory 606 can include a tangible medium retrievably storing computer-readable instructions, that when executed by the data processor 604 cause the processor to perform functions, processes, and operations described herein, for example, in reference to FIGS. 1-4.

The computer system 600 can also include a display 612, a user interface or other input device 614, and a cursor control 616, either as separate devices or combined, for example, as a touchscreen display. The computer system 600 can also include a communications interface 618, configured to interface with a local network 622 by a bus 620 for accessing a local host server 624, and to communicate through an ISP 626 to the Internet 628, and access a remote server 630.

Some implementations comprise a computer-readable storage media including executable instructions, that when executed on at least one processor, cause the processor to perform any of the above-described methods.

While various implementations have been described, the description is intended to be exemplary, rather than limiting, and it is understood that many more implementations and implementations are possible that are within the scope of the implementations. Although many possible combinations of features are shown in the accompanying figures and discussed in this detailed description, many other combinations of the disclosed features are possible. Any feature of any implementation may be used in combination with or substituted for any other feature or element in any other implementation unless specifically restricted. Therefore, it will be understood that any of the features shown and/or discussed in the present disclosure may be implemented together in any suitable combination. Accordingly, the implementations are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 106, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus the following claims are hereby incorporated into the Detailed Description, with each claim standing on its own as a separately claimed subject matter.

1. A system for automatically adapting meeting interfaces of an application providing a virtual meeting in response to detecting an acoustic signal subsequent to receiving an associated interruption symbol raising signal, the system comprising:
a processor; and
a memory, coupled to the processor, configured to store executable instructions that, when executed by the processor, cause the processor to:
receive an interruption signal, from a first meeting interface of the application providing the virtual meeting, wherein the first meeting interface is among a set of meeting interfaces associated with the application providing the virtual meeting on a respective set of client devices for a respective set of participants of the virtual meeting;
responsive to receiving the interruption signal, send the interruption symbol raising signal over a communication network to each meeting interface of the set of meeting interfaces to turn on a visual interruption symbol from a first participant;
detect a first acoustic signal at a device used by a first participant, or detect a first acoustic signal received at a network server from a device used by a first participant; and
responsive to detecting the first acoustic signal from the first participant subsequent to receiving the interruption symbol raising signal:
automatically generate an interruption symbol lowering signal; and
send to each of the set of client devices the generated interruption symbol lowering signal to automatically update each meeting interface and turn off the visual interruption symbol.

2. The system of claim 1, wherein the first acoustic signal does not comprise any voice command for turning off the visual interruption symbol.

3. The system of claim 1, wherein the visual interruption symbol is a raised hand symbol indicating that the first participant raises a virtual hand in the meeting via the first meeting interface.

4. The system of claim 1, wherein the executable instructions further include instructions that, when executed by the processor, cause the processor to:
receive a plurality of acoustic signals from a plurality of sources associated with the virtual meeting;
determine an intensity level for each of the plurality of acoustic signals; and
identify, from the plurality of acoustic signals, one or more acoustic signals having the intensity level exceeding a threshold level.

5. The system of claim 1, wherein to detect the first acoustic signal from the first participant, the executable instructions further include instructions that, when executed by the processor, cause the processor to:
recognize, from the one or more acoustic signals, one or more voices from one or more participants of the virtual meeting; and
detect whether the first participant contributes to the virtual meeting based on whether the one or more voices include a voice from the first participant.

6. The system of claim 5, wherein the executable instructions further include instructions that, when executed by the processor, cause the processor to:
determine whether the first meeting interface is in a mute status or in an unmute status; and
in response to determining that the one or more voices include the voice from the first participant and the first meeting interface is in the unmute status, generate the interruption symbol raising signal.

7. The system of claim 5, wherein the interruption symbol lowering signal is generated after a specific amount of time of detecting that the one or more voices include the voice from the first participant.

8. The system of claim 7, wherein the specific amount of time is determined from participant interactions in the virtual meeting.

9. The system of claim 5, wherein the interruption symbol lowering signal is generated upon detecting that the one or more voices no longer include the voice from the first participant.

10. The system of claim 5, wherein, prior to automatically generate the interruption symbol lowering signal, the executable instructions further include instructions that, when executed by the processor, cause the processor to notify, via the first meeting interface, the first participant of generating the interruption symbol lowering signal.

11. The system of claim 5, wherein, prior to detecting the first acoustic signal, the executable instructions further include instructions that, when executed by the processor, cause the processor to automatically turn off a mute button for the first participant.

12. The system of claim 5, wherein, prior to detecting the first acoustic signal, the executable instructions further include instructions that, when executed by the processor, cause the processor to prompt the first participant to take an unmute action.

13. A method for automatically adapting meeting interfaces of an application providing a virtual meeting in response to detecting an acoustic signal subsequent to receiving an associated interruption symbol raising signal, the method comprising:
receiving an interruption signal, from a first meeting interface of the application providing the virtual meeting, wherein the first meeting interface is among a set of meeting interfaces associated with the application providing the virtual meeting on a respective set of client devices for a respective set of participants of the virtual meeting;
responsive to receiving the interruption signal, sending the interruption symbol raising signal over a communication network to each meeting interface of the set of meeting interfaces to turn on a visual interruption symbol from a first participant;
detecting a first acoustic signal at a device used by a first participant, or detecting a first acoustic signal received at a network server from a device used by a first participant; and
responsive to detecting the first acoustic signal from the first participant subsequent to receiving the interruption symbol raising signal:
automatically generating an interruption symbol lowering signal; and
sending to each of the set of client devices the generated interruption symbol lowering signal to automatically update each meeting interface and turn off the visual interruption symbol.

14. The method of claim 13, wherein the first acoustic signal does not comprise any voice command for turning off the visual interruption symbol.

15. The method of claim 13, wherein the visual interruption symbol is a raised hand symbol indicating that the first participant raises a virtual hand in the meeting via the first meeting interface.

16. The method of claim 13, further comprising:
receiving a plurality of acoustic signals from a plurality of sources associated with the virtual meeting;
determining an intensity level for each of the plurality of acoustic signals; and
identifying, from the plurality of acoustic signals, one or more acoustic signals having the intensity level exceeding a threshold level.

17. The method of claim 16, further comprising detecting the first acoustic signal from the first participant, and wherein, to detect the first acoustic signal, the method further comprising:
recognizing, from the one or more acoustic signals, one or more voices from one or more participants of the virtual meeting; and
detecting whether the first participant contributes to the virtual meeting based on whether the one or more voices include a voice from the first participant.

18. The method of claim 17, further comprising:
determining whether the first meeting interface is in a mute status or in an unmute status; and
in response to determining that the one or more voices include the voice from the first participant and the first meeting interface is in the unmute status, generating the interruption symbol lowering signal.

19. A computer-readable storage media including executable instructions, that when executed on at least one processor, causing the processor to perform the methods according to claim 13.

20. The system of claim 2, wherein the visual interruption symbol is a raised hand symbol indicating that the first participant raises a virtual hand in the meeting via the first meeting interface.
